(19) United States
(12) Patent Application Publication
(10) Pub. No.: US 2024/0291954 A1
(43) Pub. Date: Aug. 29, 2024

(54) CAMERA SYSTEM AND METHOD FOR A CAMERA SYSTEM

(71) Applicant: Continental Autonomous Mobility Germany GmbH, Ingolstadt (DE)

(72) Inventors: Thomas Bopp, Ulm (DE); Ulrich Schaub, Ulm (DE); Tim Kreiser, Ulm (DE)

(73) Assignee: Continental Autonomous Mobility Germany GmbH, Ingolstadt (DE)

(21) Appl. No.: 18/572,768

(22) PCT Filed: Jun. 20, 2022
(86) PCT No.: PCT/DE2022/200134

§ 371 Date: Dec. 20, 2023

(30) Foreign Application Priority Data
Jun. 25, 2021 (DE) 10 2021 206 608.9

(51) Int. Cl. H04N 13/156; H04N 7/18; H04N 13/204; H04N 13/271; H04N 23/90

(52) U.S. Cl. CPC H04N 13/156; H04N 13/204; H04N 13/271; H04N 23/90; H04N 7/181

(57) ABSTRACT

A camera system for a vehicle includes two cameras to generate a camera view from camera images, with the cameras designed to capture objects at different distances from the vehicle and a scene generated based on the disparity of an object, with the disparity of the object arising from the distance of the object from the camera and the baseline spacing of the cameras from one another. At least two virtual cameras with a virtual baseline spacing from one another is created, the virtual baseline spacing of and the camera baseline spacing differing to allow the the scene to be captured with different disparities, and the camera view generated based on camera images from the cameras and the virtual cameras. The displayed camera image of the camera view is generated from the camera images and the perspective being defined by the virtual cameras using the disparity of the scene.

### CROSS-REFERENCE TO RELATED APPLICATIONS

The present application is a National Stage Application under 35 U.S.C. § 371 of International Patent Application No. PCT/DE2022/200134 filed on Jun. 20, 2022, and claims priority from German Patent Application No. 10 2021 206 608.9 filed on Jun. 25, 2021, in the German Patent and Trademark Office, the disclosures of which are herein incorporated by reference in their entireties.

### TECHNICAL FIELD

The present invention relates to a camera system or a surround view camera system for capturing the environment for a vehicle, in which a stereoscopic or holographic camera view is generated, in particular dynamically/adaptively, and a method for generating a stereoscopic or holographic view for a generic camera system, such as in conjunction with an autostereoscopic display element.

### BACKGROUND

Vehicles are increasingly being equipped with driver assistance systems which support the driver during the performance of driving maneuvers. In addition to radar sensors, lidar sensors, ultrasonic sensors and/or camera sensors, the driver assistance systems also include, in particular, surround view camera systems which allow the vehicle surroundings to be displayed to the driver of the vehicle. As a general rule, such surround view camera systems include multiple vehicle cameras which supply real images of the vehicle surroundings which are merged in particular by a data processing unit of the surround view camera system to form an image of the vehicle surroundings. The image of the vehicle surroundings can then be displayed to the driver on a display unit (such as, e.g., the display of the navigation system). In this way, the driver can be supported during a vehicle maneuver, for example when reversing the vehicle or during a parking maneuver.

For surround view as well as electronic mirror replacement systems, the camera images are either displayed directly in so-called “single views” or transformed in accordance with special processes, in order to display fused views. These views are, e.g., a so-called “3D bowl” (“bowl view” or “360 camera”) or “top view” (“bird's-eye view” or “plan view”), in which images or textures from the surround view cameras are merged or seamlessly amalgamated (stitching). As a general rule, the images or textures of the surround view cameras have overlapping areas or overlapping regions, in particular in the bowl view, in which the textures from the cameras are projected into a spatial plane in order to visualize a virtual 3D view of the surroundings which represents the entire surroundings around the car. Modern surround view camera systems can display the resulting, generated views or visualizations to the driver, e.g., by means of a conventional 2D display, in the form of a center or driver's display in the cockpit or a head-up display. The captured camera textures can be represented in various ways. 3D display elements, such as for example an autostereoscopic display, require multiple stereoscopic views of the surroundings, which are close to one another, in order to use these to communicate a realistic spatial perception to the human driver.

In order to display a spatially perceptible 3D view, for example, a 3D display element requires at least the input from two real cameras, however mostly from multiple real or virtual camera streams. The 3D effect is produced by the disparity of the two cameras. The maximum disparity is determined by the spacing of the two real cameras, the optics thereof as well as the distance of an object. A large baseline spacing is crucial for a depth effect at great distances. At the same time, close objects experience too large a parallel shift in the case of this setting, as a result of which the close range can no longer be resolved appropriately and close objects experience blurring or double images. The baseline spacing would have to be kept smaller for the close range which, in turn, has a negative effect on the depth information at a distance. With respect to such disadvantages, there is a particular interest in developing a surround view camera system focusing on such visualization functions as well as the best possible user-friendliness.

A method for monitoring a stereo camera arrangement, with image data being captured by means of two cameras and stereoscopically processed by means of a processing unit, disparities for pixels corresponding to one another in each case of a pair of images being estimated in the image processing, and a disparity map being generated from the estimated disparities, is known from DE 10 2011 108 995 A1.

Furthermore, US 2013/109869 A1 describes a surround view camera system with multiple cameras for capturing the environment for a vehicle. Attached thereto is a touch screen or a user input which makes it possible for the driver of the vehicle to selectively set the displayed images captured by the surround view camera system, e.g., to adapt the virtual viewing angle or the viewing point, to enlarge (zoom) or to pan the image in order to provide the driver with the desired displayed images for the respective driving condition or the respective scenario. The cameras have, in each case, outward-facing fields of view so that a plan view or a surround view image from the combined or synthetized images of the cameras from a virtual viewing angle can also be represented on the screen.

EP 3 410 705 A1 describes an image processing system for a motor vehicle which comprises multiple cameras which generate a stereo image, in which a stereo matching of the images is performed in order to recognize an object in the surroundings of the motor vehicle. In order to accurately calculate a disparity/depth image from the stereo camera, the two camera images must first be resampled or warped/rectified. The disparity calculation is then performed on the basis of a one-dimensional horizontal search along the columns of the image. The distance of the object is estimated on the basis of the horizontal disparity between the left and right image; the larger the horizontal disparity, the closer the object is to the camera.

### SUMMARY

The problem of the present disclosure is to therefore provide a method for a (surround view) camera system, which allows improved visibility or less visibility restrictions to be achieved more simply and in a more cost-effective way, as a result of which the user-friendliness and safety are improved.

The aforementioned problem is addressed by the entire teaching of claim 1 as well as the alternative, independent claim. Expedient embodiments of the present disclosure are claimed in the subclaims.

The camera system according to the present disclosure, in particular a surround view camera system for a vehicle, has a control device (computer, data processor, electronic control unit or ECU or the like) for controlling the camera system and for processing data and evaluating data as well as multiple (surround view) cameras for capturing the environment. The camera system according to the present disclosure includes at least two cameras which generate camera images which are composed in particular of pixels. The intention is to generate a camera view from the camera images from the cameras, with the cameras being designed to capture objects at different distances from the vehicle. A scene or scenery or a 3D visualization of the objects is generated as a function of the disparity, with the disparity arising from the distance of the respective object from the camera and the baseline spacing of the cameras from one another. Furthermore, at least two virtual cameras with a definable virtual baseline spacing from one another are created, the virtual baseline spacing of the virtual cameras and the baseline spacing of the cameras differing in that this allows an object with different disparities or values of the disparity to be captured. The displayed camera image of the camera view or display view is then generated from the camera images from the cameras and the perspective is defined by the virtual cameras on the basis of the disparity of the scene, in particular the perspective is dynamically or adaptively defined.

According to an embodiment of the present disclosure, the camera view is a stereoscopic or holographic view of the scene, which may be adaptively adjusted, i.e., the scene is adaptively stereoscopically/holographically communicated to the user or driver.

The spacing or the baseline spacing of the virtual cameras may be selected such that the latter is larger or smaller than the spacing or the baseline spacing of the real cameras.

The camera image may be expediently divided into various image regions, for example into the close range, medium range and far range, as different disparities arise therefrom for the objects to be visualized in each case. This simplifies the calculation and reduces the computational cost required.

The baseline spacing may be dynamically changed depending on the situation for all image regions or all pixels of the camera image. Accordingly, the representation of the scene and also the selection of the respective camera image are continuously adjusted to the current scene, for example while driving or in the case of moving objects. In this case, the camera image for the 3D representation of the respective object with the most favorable disparity for the 3D display is always selected.

Furthermore, a virtual camera or multiple virtual cameras with a corresponding baseline spacing may be calculated for each or virtually each pixel of a camera image or pixel by pixel in order to generate an optimal view or scene. As a result, the capturing of the objects and/or scene is further improved. For example, a shift can be calculated for a camera view which is generated from the real camera images of two cameras or a pair of stereo cameras, for each pixel.

The virtual baseline spacing may be calculated in a simple manner from the lens properties of the camera as well as the distance of the object to be visualized.

This creates an optimal scene-related calculation of virtual camera baseline spacings. As a result, the parallel shift, blurring or the lack of depth effect can be counteracted at larger distances. Furthermore, a content-related dynamic adjustment of any number of virtual camera positions is made possible with at least two fixed cameras. As a consequence, a 3D representation or a stereoscopic or holographic representation of the scene may be generated over the entire image depth, making it possible to successfully eliminate double images for close objects, improve image perception for the end user and realistically estimate distances. The depth effect may consequently be dynamically adaptively set on the basis of the method. In addition, free-standing objects may be highlighted. Moreover, the stereoscopic playback rules may be observed despite changing scenes.

According to a particular embodiment of the camera system, a fisheye camera may be provided, or a stereo camera including at least two camera units can be provided, as the camera.

More than two cameras and/or more than two virtual cameras can also be expediently provided. For example, three, four, eight, ten or more cameras or virtual cameras may be provided.

Furthermore, the present disclosure includes a method for generating a 3D view for a camera system, in particular according to any one of the preceding claims, in which at least two cameras are provided, the intention being to generate a camera view from the camera images from the cameras, with the cameras being designed to capture objects at different distances from the vehicle, and a 3D view of the objects being generated as a function of the disparity of the respective object, with the disparity of the scene arising from the distance of the object from the camera and the spacing of the cameras from one another, and two virtual cameras with a virtual spacing from one another being created, the virtual spacing of the virtual cameras and the spacing of the cameras differing in that this allows the scene to be captured with different disparities, and the camera view being generated on the basis of camera images from the cameras and the virtual cameras, the displayed camera image of the camera view being generated from the camera images from the cameras and the perspective being defined by the virtual cameras on the basis of the disparity of the scene.

### BRIEF DESCRIPTION OF THE DRAWINGS

The invention is explained in greater detail below with reference to expedient exemplary embodiments, wherein:

FIG. 1 shows a simplified schematic representation of a vehicle having a surround view camera system according to the present disclosure for generating an image of the vehicle surroundings;

FIG. 2 shows a simplified representation of an embodiment of a camera system according to the present disclosure for a vehicle, in which two real cameras capture three objects at different distances in front of the vehicle;

FIG. 3 shows a simplified representation of the relationship of capturing objects and the disparity of the real cameras of the camera system from FIG. 2;

FIG. 4 shows a simplified representation of the camera system from FIG. 2, two additional virtual cameras being generated, which capture the three objects at different distances in front of the vehicle;

FIG. 5 shows a simplified representation of the relationship of capturing objects and the disparity of the real cameras of the camera system from FIG. 4, and

FIG. 6 shows a simplified representation of the relationship of capturing objects and the disparity of the virtual cameras of the camera system from FIG. 4.

### DETAILED DESCRIPTION

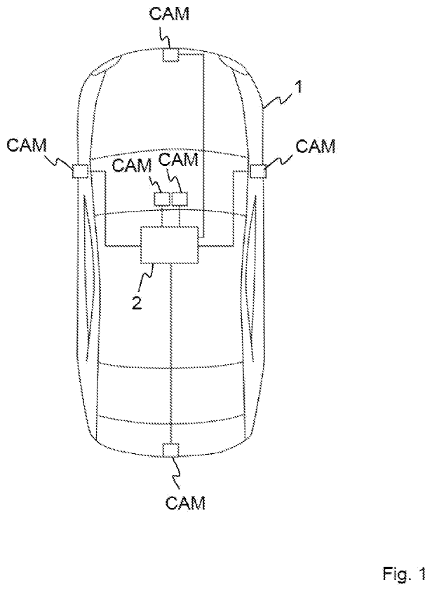

Reference numeral 1 in FIG. 1 designates a vehicle having a control device 2 (ECU, Electronic Control Unit or ADCU, Assisted and Automated Driving Control Unit), which can have recourse to various actuators (e.g., steering, engine, brake) of the vehicle 1 in order to be able to carry out control processes of the vehicle 1. Furthermore, the vehicle 1 for capturing the environment has multiple cameras CAM (surround view cameras, front camera, if necessary, stereo camera and/or the like) which are controlled via the control device 2. However, the present disclosure also expressly includes configurations in which no common control device 2 is provided, but rather individual control devices or control units are provided for controlling sensors. Moreover, further sensors such as, e.g., radar sensor(s), lidar sensor(s) and/or ultrasonic sensor(s) may also be provided. The sensor data may then be utilized in order to recognize the environment and objects. As a consequence, various assistance functions such as, e.g., a parking assistant, Electronic Brake Assist (EBA), Adaptive Cruise Control (ACC), a lane departure warning system or a Lane Keep Assist (LKA) or the like may be realized. In a practical manner, the assistance functions may likewise be carried out via the control device 2 or a separate controller.

The cameras CAM are part of a (surround view) camera system which may be controlled by the control device 2 (alternatively, e.g., a separate control can be provided), which offers a complete 360-degree view around the entire vehicle 1 by joining the fields of view of the individual cameras, e.g., 120 degrees, to form one camera view or overall view or overall image. By simply monitoring the blind spot, the camera system has numerous advantages in many everyday situations. Thanks to the camera system, various viewing angles of the vehicle 1 can be represented to the driver, e.g., via a display unit (which is not shown in FIG. 1), in particular an autostereoscopic display element. As a general rule, four cameras CAM are used, which are arranged, e.g., in the front and back as well as on the side-view mirrors. In addition, however, three, six, eight, ten or more surround view cameras can also be provided. The camera images can then be displayed as the camera view on a display or a display apparatus of the vehicle 1. The camera views are particularly helpful for illustrating the vehicle or when checking the blind spot, when changing lanes or when parking. The captured scene can be communicated to the driver as a stereoscopic/holographic view which is dynamically adaptively adjusted—a “3D image” which is dynamically adjusted to the scene is displayed to the driver, so to speak.

In the case of the camera system according to the present disclosure, for the production of a stereoscopic or holographic camera view, the baseline spacing is dynamically or adaptively changed depending on the situation for all image regions, in order to counteract parallel shift, blurriness or the lack of depth effect at larger distances. To this end, a depth image of the current scene is first produced. This can take place either by triangulation of the real camera array or with the aid of any image processing algorithms, the first method not supplying a depth image resolved to pixels. Algorithms which supply a pixel-precise depth map are better suited here. A virtual camera baseline spacing for optimal 3D representation can now be calculated for each image region, in particular for each pixel, from this information. The optimal virtual baseline spacing arises from the camera lens properties as well as from the distance of the object to be visualized, which is represented in individual pixels.

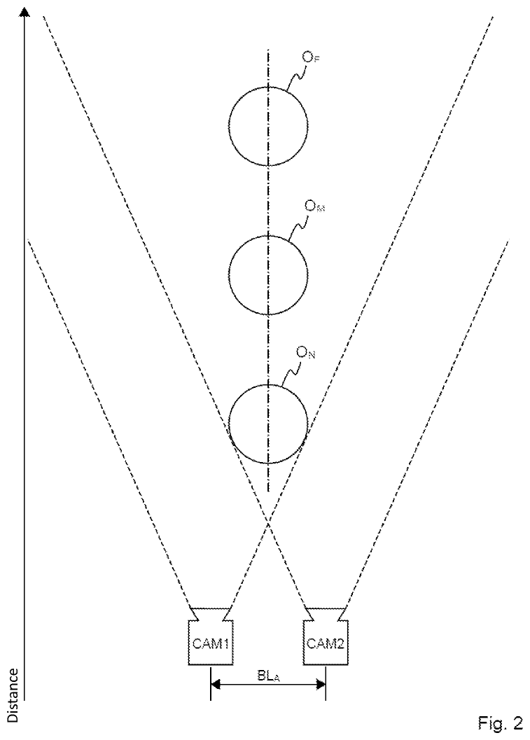

FIG. 2 depicts a typical traffic scene, in which two real cameras CAM1 and CAM2 of a vehicle 1 (e.g., surround view cameras or front cameras or two cameras of a stereo camera) capture objects in front of the vehicle 1. The objects are an object O_{N} located close to the vehicle 1, an object O_{M} located a medium distance from the vehicle 1 and an object O_{F} located a long distance from the vehicle 1. The spacing of the centers of the cameras CAM1 and CAM2 represents the baseline or the baseline spacing B_{A} of the eye. All three objects O_{N}, O_{M} and O_{F} are consequently located in the fields of view (depicted in FIG. 2 on the basis of the dashed lines) of CAM1 and CAM2, so that these can also be captured by both cameras CAM1 and CAM2. As a consequence, the objects O_{N}, O_{M} and O_{F} can indeed be visualized or represented, but not also to the same extent in 3D.

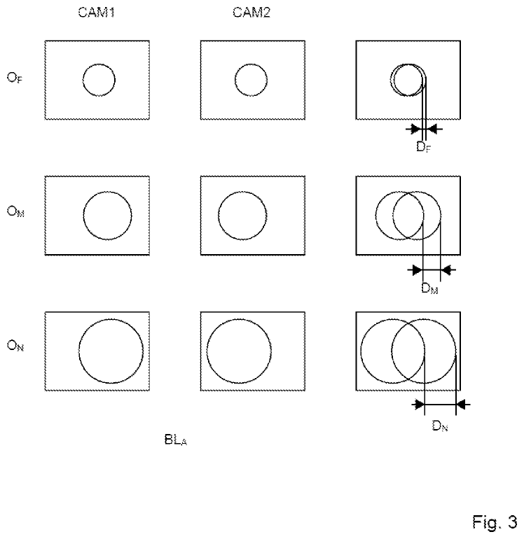

FIG. 3 depicts how the cameras CAM1 and CAM2 capture the objects O_{N}, O_{M} and O_{F} and what disparity arises therefrom (right side). In this case, it becomes apparent that the disparity D_{F} for the object O_{F} is too low in order to represent a 3D effect. In contrast, the disparity D_{N} for the object O_{N} cannot be resolved. Ultimately, a double image is created for the object O_{N}. A 3D effect cannot be represented here. For the object O_{M}, the disparity D_{M} is, in turn, in a range in which a 3D effect can be easily generated or represented. Accordingly, all the objects O_{N}, O_{M} and O_{F} are indeed easily recognized; however, a 3D effect can not only be represented for the object O_{M}.

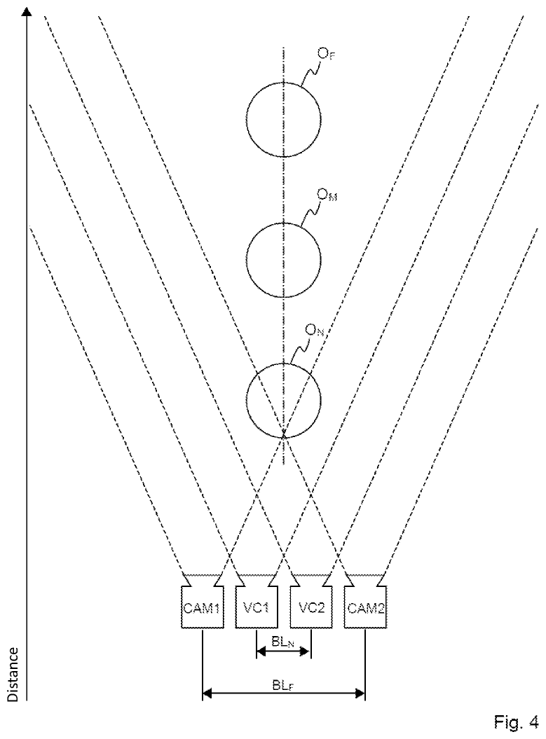

FIG. 4 shows the traffic scene from FIG. 2, in which in addition to the two real cameras CAM1 and CAM2, two virtual cameras VC1 and VC2 are generated. The spacing of the centers of the cameras CAM1 and CAM2 represents the baseline or the baseline spacing BF for the far range since the latter are further apart. The virtual cameras are now positioned in such a way that the baseline spacing thereof is small enough to map the close range B_{N}. The objects O_{M} and O_{F} are consequently located in the fields of view of CAM1 and CAM2, and the objects O_{M} and O_{N} in the fields of view of VC1 and VC2.

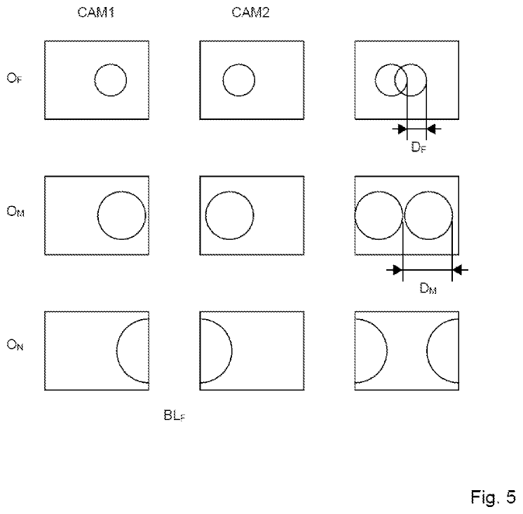

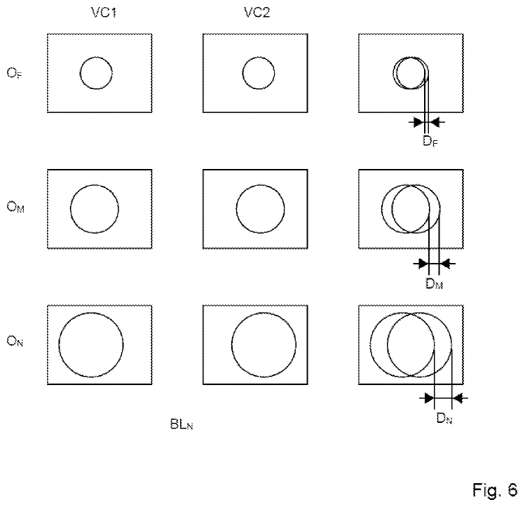

FIG. 5 depicts how the cameras CAM1 and CAM2 capture the objects O_{N}, O_{M} and O_{F} and what disparity results therefrom (right side). In this case, it becomes apparent that the disparities D_{M} and D_{N} for the object O_{F} are too large or cannot be resolved, so that a double image is created in each case here for the objects O_{M} and O_{N}. A 3D effect cannot therefore be represented. For the object O_{F} the disparity is, in turn, in a range in which a 3D effect can be easily generated or represented. Furthermore, FIG. 6 depicts how the virtual cameras VC1 and VC2 capture the objects O_{N}, O_{M} and O_{F} and what disparity arises therefrom (right side). In this case, it becomes apparent that the disparities D_{M} and D_{F} are too small for the objects O_{M} and O_{F}, so that no 3D object can be generated for the objects O_{M} and O_{F}. Admittedly, it becomes apparent that the disparity D_{N} lies in a range which permits a 3D representation. Accordingly, thanks to the targeted generation of the virtual cameras VC1 and VC2, as well as the definable spacing thereof, all the objects O_{N}, O_{M} and O_{F} can be easily recognized and represented with a 3D effect.

### LIST OF REFERENCE NUMERALS

1 Vehicle
2 Control device
CAM Camera
CAM1 Real camera
CAM2 Real camera
VC1 Virtual camera
VC2 Virtual camera
O_{N} Object (close-range)
O_{M} Object (medium-range)
O_{F} Object (far-range)
BL_{A} Baseline (eye)
BL_{N} (Virtual) baseline (close-range)
BL_{F} Baseline (far-range)
D_{N} Disparity (close-range)
D_{M} Disparity (medium-range)
D_{F} Disparity (far-range)

1. A camera system, in particular a surround view camera system, for a vehicle, comprising
at least two cameras which generate a camera view from camera images from the cameras, with the cameras being configured to capture objects at different distances from the vehicle, and
at least one processor which generates a scene as a function of a disparity of at least one object, with the disparity of the at least one object arising from a distance of the at least one object from the camera and a baseline spacing of the cameras from one another,
wherein the at least one processor creates at least two virtual cameras with a virtual baseline spacing from one another, the virtual baseline spacing of the virtual cameras and the baseline spacing of the cameras differing to allow for the scene to be captured with different disparities,
wherein the camera view is generated on the basis of the camera images from the cameras and the virtual cameras, the at least one processor generates a displayed camera image of the camera view from the camera images from the cameras and a perspective being defined by the virtual cameras on the basis of the disparity of the scene.

2. The camera system according to claim 1, wherein the camera view is a stereoscopic or holographic view of the scene.

3. The camera system according to claim 1, wherein the virtual baseline spacing of the virtual cameras is selected such that the virtual baseline spacing is larger or smaller than the baseline spacing of the cameras.

4. The camera system according to claim 1, wherein the camera image is divided into various image regions.

5. The camera system according to claim 4, wherein the baseline spacing of the cameras is dynamically changed depending on a situation for all image regions or all pixels of the camera image.

6. The camera system according to claim 1, wherein a virtual camera of the at least two virtual cameras with a corresponding virtual baseline spacing is calculated for each pixel of the camera image in order to generate an optimal scene.

7. The camera system according to claim 1, wherein the virtual baseline spacing is calculated from lens properties of a camera of the at least two cameras as well as the distance of the at least one object to be visualized or the scene to be visualized.

8. The camera system according to claim 1, wherein a fisheye camera or a stereo camera comprising at least two camera units is provided as the at least two cameras.

9. The camera system according to claim 1, wherein more than two cameras and/or more than two virtual cameras are provided.

10. A method for generating a stereoscopic or holographic camera view for a camera system, in particular according to any one of the preceding claims, in which
providing at least two cameras to generate the camera view from camera images from the cameras, with the cameras being configured to capture objects at different distances from the vehicle, and
generating, with at least one processor, a scene as a function of a disparity of at least one object, with the disparity of the at least one object arising from a distance of the at least one object from the camera and a spacing of the cameras from one another, and
creating, with the at least one processor, two virtual cameras with a virtual spacing from one another, the virtual spacing of the virtual cameras and the spacing of the cameras differing in order for the at least one object to be captured with different disparities,
generating, with the at least one processor, the camera view on the basis of camera images from the cameras and the virtual cameras, and
generating, with the at least one processor, a displayed camera image of the camera view from the camera images from the cameras and a perspective being defined by the virtual cameras on the basis of the disparity of the scene.

11. The camera system according to claim 2, wherein the camera view is a stereoscopic or holographic view of the scene, which is adaptively adjusted.
